(19) United States
(12) Patent Application Publication
(10) Pub. No.: US 2020/0077625 A1
(43) Pub. Date: Mar. 12, 2020

(54) INDIVIDUAL IDENTIFICATION DEVICE, INDIVIDUAL IDENTIFICATION SYSTEM, CONTROL METHOD FOR INDIVIDUAL IDENTIFICATION DEVICE, AND STORAGE MEDIUM

(71) Applicant: SHARP KABUSHIKI KAISHA, Sakai City, Osaka (JP)

(72) Inventor: KENICHI SANUKI, Sakai City (JP)

(21) Appl. No.: 16/462,682

(22) PCT Filed: Aug. 28, 2017
(86) PCT No.: PCT/JP2017/030811

§ 371 Date: May 21, 2019

(30) Foreign Application Priority Data
Nov. 24, 2016 (JP) 2016-228227

(51) Int. Cl. A01K 29/00; G01G 17/00; A01K 1/01

(52) U.S. Cl. CPC A01K 29/005; A01K 1/0107; G01G 17/00

(57) ABSTRACT

The present invention accurately identifies an individual which is present in a certain region. A control section (10) includes: a weight obtaining section (100) configured to obtain a weight; an action information obtaining section (101) configured to obtain action information; a weight change detecting section (102) configured to detect at least one of entrance and exit timings and a stay period; and an individual identifying section (104) configured to identify, based on action information in at least one of the entrance and exit timing and the stay period, an individual which stayed in the certain region.

### TECHNICAL FIELD

The present invention relates to, for example, an individual identifying device configured to identify individual animals present in a certain region.

### BACKGROUND ART

In a case of raising an animal such as a pet, it is important to measure a body weight periodically. Patent Literature 1 discloses an automatic body weight measuring system for pets which (i) is installed underneath a table for pet, (ii) measures a weight of the table when a pet is on the table and a weight of the table when the pet is not on the table, (iii) calculates a weight of the pet, and (iv) outputs, by display, the weight of the pet.

### CITATION LIST

### Patent Literature

[Patent Literature 1]

Japanese Patent Application Publication, Tokukai, No. 2007-330200 (Publication Date: Dec. 27, 2007)

[Patent Literature 2]

Japanese Patent Application Publication, Tokukai, No. 2016-080620 (Publication Date: May 16, 2016)

### SUMMARY OF INVENTION

### Technical Problem

According to the technique disclosed in Patent Literature 1, however, which animal is present on a weight scale is difficult to identify in a case where a plurality of animals are located in the vicinity of the weight scale at the time of measurement of body weights. Meanwhile, as a technique for identifying individual animals, there is a technique for carrying out facial recognition for an animal with use of a camera. However, in a case where the technique is used, it is necessary that the animal looks at the camera for a certain period of time. In the identification of the individuals by use of the above technique, therefore, the accuracy of the identification decreases considerably unless (i) a direction in which the animal is facing can be identified and (ii) the animal is stationary for a certain period of time.

An aspect of the present invention has been made in view of the problem, it is an object of the present invention to achieve, for example, an individual identifying device configured to accurately identify an animal individual which is present in a certain region.

### Solution to Problem

In order to attain the object, an individual identifying device in accordance with an aspect of the present invention includes: a weight obtaining section configured to obtain, at certain time intervals, a weight applied to a certain region; an action information obtaining section configured to obtain one or more pieces of action information on respective ones of one or more animals, each of the one or more pieces of action information indicating whether or not a corresponding one of the one or more animals is moving; a weight change detecting section configured to detect at least one of a timing and a period in each of which a change over time in the weight obtained by the weight obtaining section indicates a certain change; and an individual identifying section configured to identify, based on the one or more pieces of action information in at least one of the timing and the period, an individual which stayed in the certain region.

In order to attain the object, an individual identifying device controlling method in accordance with an aspect of the present invention includes the steps of: (a) obtaining, at certain time intervals, a weight applied to a certain region; (b) obtaining one or more pieces of action information on respective ones of one or more animals, each of the one or more pieces of action information indicating whether or not a corresponding one of the one or more animals is moving; (c) detecting at least one of a timing and a period in each of which a change over time in the weight obtained in the step (a) indicates a certain change; and (d) identifying, based on the one or more pieces of action information in at least one of the timing and the period, an individual which stayed in the certain region.

### Advantageous Effects of Invention

According to an aspect of the present invention, individuals present in a certain region can be accurately identified.

### BRIEF DESCRIPTION OF DRAWINGS

FIG. 1 is a block diagram illustrating a main configuration of a management system in accordance with Embodiment 1.

FIG. 2 is a view illustrating an overview of the management system.

(a) through (d) of FIG. 3 are diagrams illustrating a positional relationship between (i) actions of two animals wearing respective collars which are constituent elements of the management system and (ii) an animal toilet.

FIG. 4 is a view illustrating a relationship between (i) a change in weight measured by a weight scale of the animal toilet and (ii) an acceleration detected by acceleration sensors of collars attached to animals illustrated in (a) through (d) of FIG. 3.

FIG. 5 is a flowchart illustrating a flow of a process performed by a control section of the animal toilet.

FIG. 6 is a set of flowcharts illustrating flows of score calculation processes performed by a score calculating section of the control section.

### DESCRIPTION OF EMBODIMENTS

### Embodiment 1

«Overview of Management System 500»

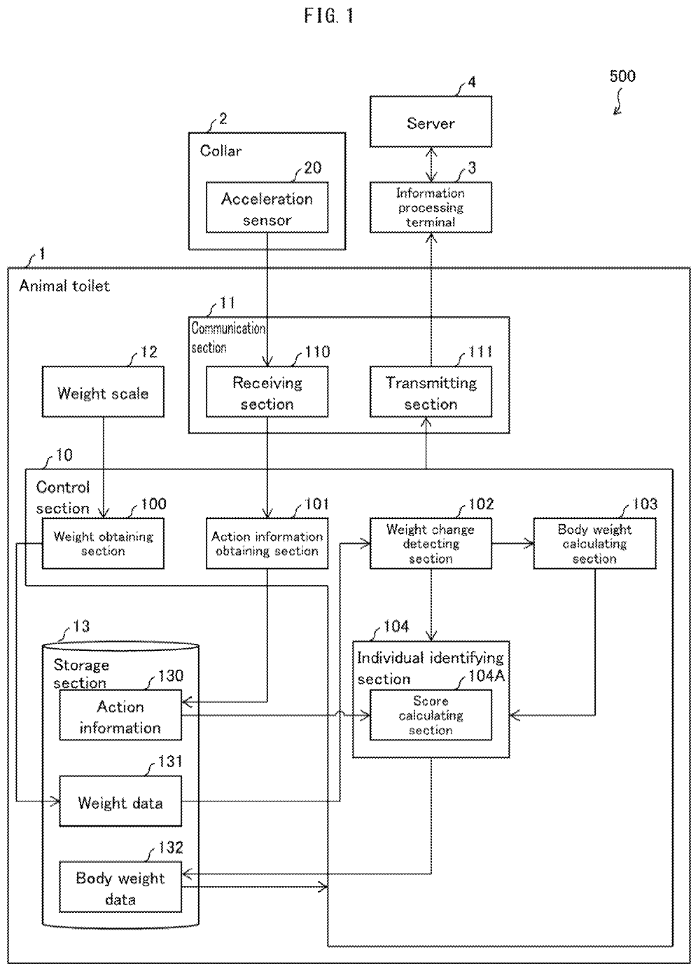

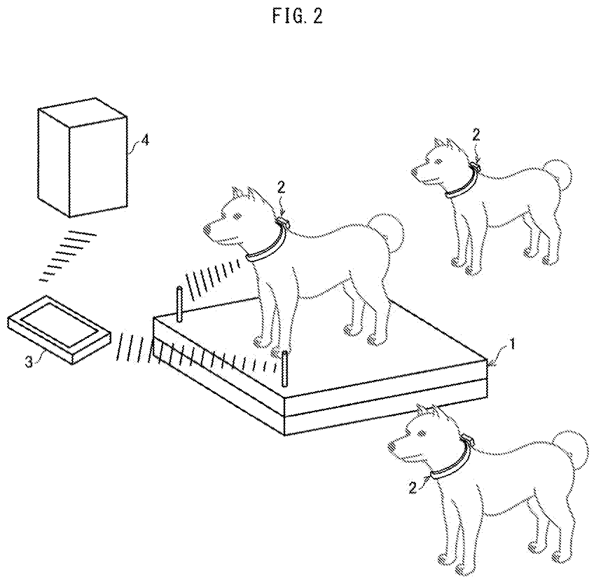

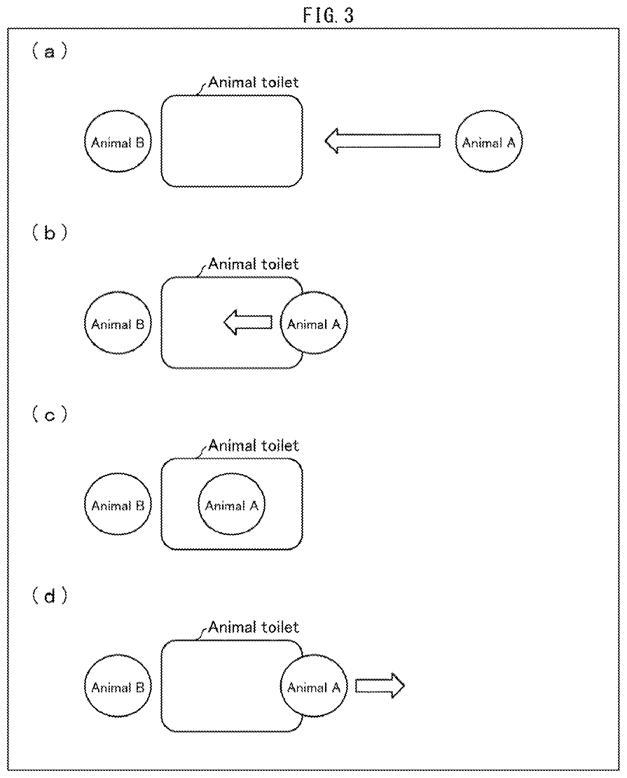

The following description will discuss an embodiment of the present invention with reference to FIGS. 1 through 6. FIG. 2 is a view illustrating an overview of a management system (individual identifying system) 500. The management system 500 includes at least an animal toilet 1 and a collar 2. The management system 500 may further include an information processing terminal 3 and server 4.

The collar 2 is a collar to be attached to an animal and includes an acceleration sensor. The collar 2 detects an acceleration of the animal wearing the collar 2, and then determines, based on the acceleration, whether or not the animal is in a state of moving (active state) or in a state of being stationary (stationary state). The collar 2 transmits the determination result to the animal toilet 1. Note that there can be a plurality of collars 2. Specifically, there can be one or more animals wearing respective collars 2.

The animal toilet 1 is a toilet in which a weight scale is provided. The weight scale of the animal toilet 1 measures a weight applied to a certain region of the animal toilet 1 (e.g., a floor surface of the toilet). This allows, in a case where an animal uses the toilet (i.e., in a case where the animal excreted in the toilet), the animal toilet 1 to measure a body weight of the animal. Based on a change in the weight measured by the weight scale, the animal toilet 1 identifies (i) a timing (entrance timing) at which the animal entered the toilet and (ii) a timing (exit timing) at which the animal exited the toilet. The animal toilet 1 also identifies a stay period for which the animal stayed in the toilet. In each of the above entrance timing, the exit timing, and the stay period, the animal toilet 1 identifies whether or not each individual wearing the collar 2 is in an active state or a stationary state. Based on the results of the identification, the animal toilet 1 (i) identifies which of the individuals wearing the respective collars 2 used the toilet and (ii) records, as a body weight of the individual that used the toilet, the body weight measured by the weight scale. At a certain timing or in response to a request for data, the animal toilet 1 transmits, to the information processing terminal 3, records of respective body weights of the individuals.

The information processing terminal 3 transmits, to the server 4, the received records of the body weights. The server 4 accumulates and manages the records of the body weights thus received. According to the management system 500, there can be a plurality of animal toilets 1, a plurality of information processing terminals 3, and/or a plurality of servers 4. The animal toilet 1 can receive action information from a plurality of collars 2. In a case where there are a plurality of animal toilets 1, each of the animal toilets 1 can (i) identify whether or not a collar 2 is associated with the animal toilet 1 and (ii) receive action information from the collar 2 which is thus associated with the animal toilet 1. The information processing terminal 3 can collect records of body weights from a plurality of animal toilets 1. The server 4 can also collect records of body weights from a plurality of information processing terminals 3. The server 4 can be a group of plurality of servers. Alternatively, the server 4 can be a cloud storage instead of a physical server.

«Main Configuration of Management System 500»

FIG. 1 is a block diagram illustrating a main configuration of the management system 500. The information processing terminal 3 and the server 4 have already been described with reference to the FIG. 2, and therefore will not be described in this section.

(Collar 2)

The collar 2 is a collar for animals, and includes an acceleration sensor (action information detecting device) 20. A shape of the collar 2 and a method of attaching the collar 2 to an animal are not limited, provided that the collar 2 can be attached to the animal. For example, instead of the collar 2, it is possible to use a tag to be attached to an ear or a tail of the animal.

The acceleration sensor 20 detects, at certain time intervals (e.g., every second), an acceleration of an animal wearing collar 2. Furthermore, the acceleration sensor 20 determines whether or not the animal wearing the collar 2 is in a state of moving (active state) or in a state of being stationary (stationary state). For example, in a case where the detected acceleration is not less than a certain threshold (acceleration threshold), the acceleration sensor 20 determines that the animal is in the active state. In a case where the detected acceleration is less than the acceleration threshold, the acceleration sensor 20 determines that the animal is in the stationary state. The acceleration sensor 20 transmits, to the animal toilet 1, information (action information) in which information indicating whether or not the individual is in the active state or the stationary state is associated with information identifying the individual.

The above determination can be performed by, instead of the acceleration sensor 20, an action information obtaining section 101 (described later) of the animal toilet 1. In such a case, the acceleration sensor 20 transmits, to the animal toilet 1, acceleration data in which the detected acceleration is associated with detection time at which the acceleration was detected. In a case where the animal toilet 1 receives the acceleration data, the animal toilet 1 obtains action information by performing the above determination based on the acceleration data.

The collar 2 can include, instead of the acceleration sensor 20, an angular velocity sensor. As in the case of the acceleration sensor 20, the angular velocity sensor can also (i) detect, as an angular velocity, a movement of an animal and then (ii) determine, based on whether or not the detected angular velocity is a certain threshold or more, whether or not the animal is in an active state or a stationary state.

(Animal Toilet 1)

The animal toilet 1 includes a communication section 11, a weight scale (weight measuring device) 12, a control section (individual identifying device) 10, and a storage section 13. The communication section 11 is a communication interface between the animal toilet 1 and an external device. The communication section 11 includes a receiving section 110 and a transmitting section 111. The receiving section 110 receives the acceleration data from the acceleration sensor 20 of the collar 2, and then transmits the acceleration data to the action information obtaining section 101 (described later) of the control section 10. The transmitting section 111 receives, from the control section 10, body weight data 132 (described later) on respective individual animals. Then, the transmitting section 111 transmits the body weight data 132 to the information processing terminal 3. The communication section 11 can communicate with the collar 2 or the information processing terminal 3 through, for example, near field communication such as Bluetooth (registered trademark).

The weight scale 12 measures, at certain time intervals (e.g., every second), a weight applied to a certain region of the animal toilet 1. The weight scale 12 can detect the weight by, for example, detecting a change in pressure with use of a load cell. The weight scale 12 transmits, to the weight obtaining section 100 (described later) of the control section 10, weight data which is information in which the weight thus measured is associated with time (measurement time) at which the weight was measured.

The weight data to be transmitted from the weight scale 12 to the weight obtaining section 100 can be information in which measurement time is associated with a value (i.e., an amount of change in weight) obtained by subtracting a base value (measurement value when no weight is being applied to the certain region of the animal toilet 1) from the measured weight.

The weight scale 12 can include an amplifier (AMP) and an analog to digital converter (ADC). In such a case, the weight scale 12 can (i) amplify the detection value with use of the AMP, (ii) convert the amplified detection value, which is an analog signal, into a digital signal with use of the ADC, and (iii) transmit the digital signal to the weight obtaining section 100.

The storage section 13 stores various pieces of data used by the animal toilet 1. The storage section 13 stores action information 130, weight data 131, and the body weight data 132. The storage section 13 also stores (i) thresholds (a first threshold and a second threshold) and numerical range settings which are used for various determinations in the control section 10 and (ii) the base value of the weight scale 12.

The action information 130 is a group of a series of data in which action information, which the animal toilet 1 receives from the collars 2, is recorded for each individual and in chronological order. The action information 130 is read out by an individual identifying section 104 (described later). The weight data 131 is group of a series of data in which weight data is recorded in chronological order. The weight data 131 is read out by a weight change detecting section 102 (described later). The body weight data 132 is a group of a series of data in which values of the body weights (body weight value) of animals which stayed in the certain region of animal toilet 1 are recorded for each individual. Note that the body weight data 132 can be information in which the body weight value is associated with (i) time at which the body weight value was calculated or (ii) measurement time of the weight data 131 from which the body weight value was calculated.

Alternatively, instead of including the storage section in the animal toilet 1, it is possible to store the above-described various data in a storage section of the information processing terminal 3 or of the server 4. In such a case, the animal toilet 1 can then receive, as appropriate, necessary data via the receiving section 110 of the communication section 11.

The control section 10 centrally controls the animal toilet 1. The control section 10 is achieved with use of, for example, a central processing unit (CPU). The control section 10 includes the weight obtaining section 100, the action information obtaining section 101, the weight change detecting section 102, a body weight calculating section 103, and the individual identifying section 104.

The weight obtaining section 100 obtains weight data from the weight scale 12. Then, the weight obtaining section 100 records the weight data as one record of the weight data 131 stored in the storage section 13. This causes pieces of weight data to be accumulated in chronological order in the weight data 131.

The action information obtaining section 101 obtains action information from the acceleration sensor 20 of the collar 2 via the receiving section 110. Then, the action information obtaining section 101 records the action information as one record of the action information 130 which is recorded for each individual and is stored in the storage section 13. This causes pieces of action information to be accumulated in the action information 130 for each individual and in chronological order.

Through referring to the weight data 131 stored in the storage section 13, the weight change detecting section 102 detects at least one of timings and a period at/in which a weight-change over time indicates a certain change. Note that the “timing” as used herein can be a certain point in time, or can be a certain period including a certain time point as a middle point (for example, a period including time points 1 second before and after a specific time point). The same applies to the following descriptions.

The weight change detecting section 102 in accordance with Embodiment 1 detects an entrance timing (first timing), an exit timing (second timing), and a stay period (weight stable period). Specifically, the weight change detecting section 102 detects, as an entrance timing, a timing at which a weight indicated by the weight data 131 has become more than a base value by not less than a first threshold. In addition, the weight change detecting section 102 detects, as an exit timing, a timing at which the weight indicated by the weight data 131 has become more than the base value by less than a second threshold. In other words, of all the records in the weight data 131, the weight change detecting section 102 can set, as the entrance timing, measurement time recorded in a record in which a value obtained by subtracting the base value from the weight is not less than the first threshold. In addition, of all the records in the weight data 131, the weight change detecting section 102 can set, as the exit timing, measurement time recorded in a record in which the value obtained by subtracting the base value from the weight is less than the second threshold.

The values of the first threshold and the second threshold can each be set as appropriate according to an actual body weight of an animal. The first threshold and the second threshold can be an identical value or can be differing values. For example, in a case where an animal is a pet such as a dog or a cat, the first threshold and the second threshold can be approximately 500 g.

In addition, the weight change detecting section 102 refers to the series of the records in the weight data 131, and detects, as a stay period, a period in which the amount of change in the weight indicated by the weight data 131 falls within a certain range of values for a certain time period (e.g., 5 seconds). The weight change detecting section 102 transmits, to the individual identifying section 104, the entrance timing, the exit timing, and the stay period which have been thus detected. In addition, the weight change detecting section 102 transmits, to the body weight calculating section 103, the stay period which has been thus detected. Note that the certain range can also be set as appropriate according to the actual body weight of the animal. For example, in a case where the animal is a pet such as a dog or a cat, the values of the certain range can be approximately 50 g.

The body weight calculating section 103 calculates a body weight value of an animal which stayed in the certain region of the animal toilet 1. In a case where the body weight calculating section 103 has receives the stay period from the weight change detecting section 102, the body weight calculating section 103 calculates a body weight value based on the weight data 131 in the stay period. For example, the body weight calculating section 103 calculates a value obtained by subtracting the base value of the weight scale 12 from an average value of the weights indicated by each of the weight data 131, and then sets the value as a body weight value. The body weight calculating section 103 transmits, to the individual identifying section 104, the body weight value thus calculated.

The individual identifying section 104 identifies which of the animals wearing the respective collars 2 is the animal which stayed in the certain region of the animal toilet 1. The individual identifying section 104 includes a score calculating section 104A. Based on action information at the entrance timing, the exit timing, and the stay period, the score calculating section 104A scores individual animals wearing the respective collars 2. According to Embodiment 1, the score calculating section 104A adds points to (i) an individual(s) which is in an active state at the entrance timing and the exit timing and (ii) an individual(s) which is in a stationary state in the stay period. By comprehensively examining the scores at the entrance timing, the stay period, and the exit timing, the individual identifying section 104 identifies an individual which stayed in the certain region of animal toilet 1. For example, the individual identifying section 104 identifies, as an individual which stayed in the certain region of the animal toilet 1, an individual for which a sum of scores, among the scores for individuals, is highest.

Note that points to be added to the entrance timing, the exit timing, and the stay period can be different from each other. For example, in a case where an individual is in a stationary state in a stay period, the score calculating section 104A can give particularly higher points at the entrance timing and the exit timing in comparison with a case where the individual is in an active state in the stay period. According to Embodiment 1, the score calculating section 104A scores individual animals by adding points. Alternatively, it is possible to score individual animals by subtracting points. In such a case, the individual identifying section 104 identifies, as an individual which stayed in the certain region, an individual having a lowest score.

In a case where the individual identifying section 104 has identified the individual which stayed in the certain region, the individual identifying section 104 (i) associates the body weight value, which has been received from the body weight calculating section 103, with information indicating the individual thus identified, and then (ii) records associated data in the body weight data 132 of the storage section 13.

(Movement, Measured Weight, and Acceleration of Animal)

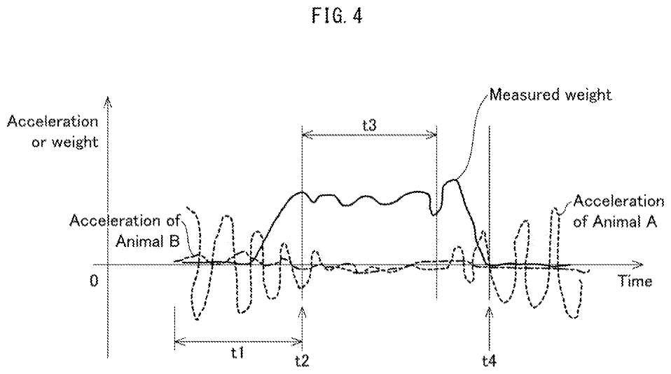

The following description will discuss, with reference to FIGS. 3 and 4, a relationship between (i) an action of each individual of animals wearing the respective collars 2 and (ii) a weight measured by the weight scale 12 of the animal toilet 1. (a) through (d) of FIG. 3 are diagrams illustrating a positional relationship between (i) actions of two animals (an animal A and an animal B) wearing respective collars 2 and (ii) the animal toilet 1. FIG. 4 is a view illustrating a relationship between (i) a change in weight measured by the weight scale 12 of the animal toilet 1 and (ii) an acceleration detected by the acceleration sensors of the collars 2 attached to the animals A and B illustrated in (a) through (d) of FIG. 3.

t1 through t4 in FIG. 4 indicate timings/periods of (a) through (d) of FIG. 3, respectively. Although the examples of FIGS. 3 and 4 discuss two animals, the number of individual animals wearing collars 2 is not limited to any particular one.

In a case where (i) neither the animals A nor B is present in the animal toilet 1 and (ii) the animal A is moving ((a) of FIG. 3), an acceleration of the animal A is constantly changing and an acceleration of the animal B is substantially unchanging, as indicated in t1 of FIG. 4.

In a case where the animal A enters the animal toilet 1 (enters a certain region of the animal toilet 1) ((b) of FIG. 3), the weight scale 12 detects the weight of the animal A. This causes a measured weight to increase, as indicated at t2 of FIG. 4. In so doing, since the animal A is moving so as to enter the room, the acceleration of the animal A is changing, while the acceleration of the animal B is substantially unchanging.

Subsequently, in a case where the animal A is using the animal toilet 1 ((c) of FIG. 3), the weight of measure by the weight scale 12 is substantially stable at (a base value+the body weight value of the animal A), as indicated in the period t3 of FIG. 4. In so doing, since both the animal A and the animal B are stationary, respective the accelerations of the animals A and B are substantially unchanging.

In a case where the animal A exits the animal toilet 1 (exiting the certain region) ((d) of FIG. 3), the weight scale 12 no longer detects the weight of the animal A. This causes the measured weight to decrease to the base value, as indicated at t4 of FIG. 4. In so doing, since the animal A is moving so as to exit the room, the acceleration of the animal A is changing, while the acceleration of the animal B is substantially unchanging.

It can thus be said that an animal using the animal toilet 1 is (i) moving at the time of entrance to and exit from the animal toilet 1 and (ii) stationary during a period (t3) in which a weight measured by the weight scale 12 is stable. The individual identifying section 104 of the control section 10 thus identifies, according to action information at the entrance timing, the exit timing, and the stay period, an individual which used the animal toilet 1. This allows the individual identifying section 104 to accurately identify the individual.

(Flow of Process Performed by Animal Toilet 1)

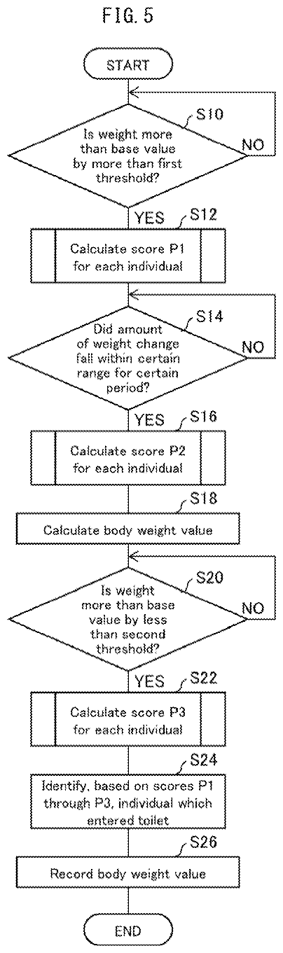

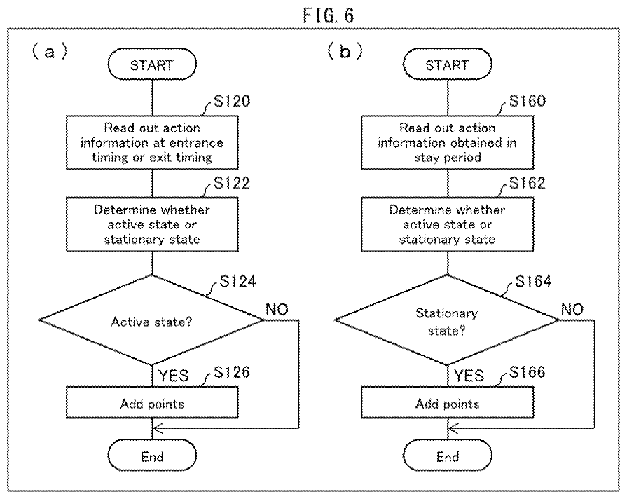

A flow of a process performed by the control section 10 of the animal toilet 1 will be described below with reference to FIGS. 5 and 6. FIG. 5 is a flowchart illustrating the flow of the process performed by the control section 10. FIG. 6 is a set of flowcharts illustrating the flows of score calculation processes performed by the score calculating section 104A of the control section 10. In the flowchart of FIG. 5, the following are assumed to have been started: (i) detection and transmission of an active state which are performed by the acceleration sensor 20 of the collar 2 and (ii) weight measurement performed by the weight scale 12 of the animal toilet 1.

The weight obtaining section 100 of the animal toilet 1 obtains weight data from the weight scale 12 at certain time intervals, and records the weight data in the weight data 131 (weight obtaining step). The action information obtaining section 101 obtains action information from the acceleration sensor 20 of the collar 2 at certain time intervals, and records the action information in the action information 130 (action information obtaining step). The weight change detecting section 102 determines whether or not a weight indicated by the weight data 131 has become more than a base value by not less than a first threshold (S10, weight change detecting step). In a case where the weight has become more than the base value by not less than the first threshold, (YES in S10), the time is detected as an entrance timing, and the entrance timing is transmitted to the individual identifying section 104. The score calculating section 104A of the individual identifying section 104 calculates a score (score P1) at the entrance timing for each individual (S12). Note that while the weight indicated by the weight data 131 has not become more than the base value by not less than the first threshold (NO in S10), the weight change detecting section 102 does not detect the entrance timing.

(a) of FIG. 6 illustrates the flow of the score calculation process in S12 of FIG. 5. The score calculating section 104A reads out the action information at the entrance timing from the action information 130 (S120), and then determines whether or not the action information indicates an active state or a stationary state (S122, first determination, third determination). In a case where the action information indicates the active state (YES in S124), the score calculating section 104A adds a point(s) to a score P1 (S126). In a case where the action information indicates the stationary state (NO in the S124), the score calculating section 104A does not add any points to the score P1.

The weight change detecting section 102 also determines whether or not an amount of change in the weight indicated by the weight data 131 falls within a certain range for a certain time period (S14, weight change detecting step). In a case where the amount of change falls within the certain range (YES in S14), (i) a period in the certain time period is detected as a stay period and (ii) the stay period is transmitted to the individual identifying section 104. The score calculating section 104A of the individual identifying section 104 calculates a score (score P2) in the stay period for each individual (S16). Note that while the amount of change in the weight indicated by the weight data 131 does not fall within the certain range (NO in S14), the weight change detecting section 102 does not detect the stay period.

(b) of FIG. 6 illustrates the flow of the score calculation process in S16 of FIG. 5. The score calculating section 104A reads out the action information in the stay period from the action information 130 (S160), and then determines whether or not the action information indicates an active state or a stationary state (S162, second determination). In a case where action information indicates the stationary state (YES in S164), the score calculating section 104A adds a point(s) to the score P2 (S166). In a case where the action information indicates the active state (NO in S164), the score calculating section 104A does not add any points to the score P2.

The weight change detecting section 102 also transmits the stay period to the body weight calculating section 103. The body weight calculating section 103 calculates a body weight value based on the weight data 131 in the stay period (S18). The body weight calculating section 103 transmits, to the individual identifying section 104, the body weight value thus calculated.

The weight change detecting section 102 further determines whether or not the weight indicated by the weight data 131 has become more than a base value by less than a second threshold (S20, weight change detecting step). In a case where the weight has become more than the base value by less than the second threshold, (YES in S20), the weight change detecting section 102 detects the time as an exit timing, and then transmits the exit timing to the individual identifying section 104. The score calculating section 104A of the individual identifying section 104 calculates a score (score P3) at the exit timing for each individual (S22). The score calculation process in S22 is similar to the flow of the score calculation process in S12. Note that while the weight indicated by the weight data 131 has not become more than the base value by less than the second threshold (NO in S20), the weight change detecting section 102 does not detect the exit timing.

In a case where the scores P1 through P3 have been calculated in S12, S16, and S22, the individual identifying section 104 identifies, based on the scores P1 through P3, an individual which entered the animal toilet 1 (S24, individual identifying step). For example, the individual identifying section 104 identifies, as the individual which entered the animal toilet 1, an individual for which a sum of scores calculated by the score calculating section 104A is highest among the scores for individuals. Furthermore, in a case where the individual identifying section 104 has obtained the body weight value from the body weight calculating section 103, the individual identifying section 104 (i) associates the body weight value with information identifying the individual and (ii) records associated data in the body weight data 132 of the storage section 13 (S26).

According to the process above, it is possible to identify an animal, which stayed in the certain region of the animal toilet 1, by comprehensively examining the active state in each of the entrance timing, the exit timing, and the stay period. It is therefore possible to identify the individual more accurately than in a case where the individual is identified based on the active state in one of the timings and the period.

Note that in the case of YES in S14, the process in S18 performed by the body weight calculating section 103 can be performed at any point between the process in S14 and the process in S26. The weight change detecting section 102 can perform the determining process of S10, S14, and S20, irrespective of the progress in the processes of S12, S16, and S18.

### Embodiment 2

The individual identifying section 104 can calculate the scores P1 through P3 to identify an individual in real time, and can record a body weight value of the individual as body weight data 132 of the storage section 13. The following description will discuss Embodiment 2 of the present invention. For convenience, members having functions identical to those of the members described in Embodiment 1 are given identical reference signs, and their descriptions are omitted. This also applies to the Embodiment 3.

A weight obtaining section 100 in accordance with Embodiment 2 either (i) does not record obtained weight data in weight data 131 of a storage section 13 or (ii) records the weight data in the weight data 131 and transmits the weight data to a weight change detecting section 102. An action information obtaining section 101 in accordance with Embodiment 2 either (i) does not record obtained action information in an action information 130 of the storage section 13 or (ii) records the action information in the action information 130 and transmits the action information to the individual identifying section 104.

The weight change detecting section 102 constantly monitors a change in weight indicated by the weight data received from the weight obtaining section 100. As soon as the change in weight indicated by the series of weight data thus monitored satisfies detection conditions of the entrance timing, the exit timing, and the stay period, the weight change detecting section 102 notifies the individual identifying section 104 of these timings and period. In a case where the detection condition of the stay period is satisfied, the weight change detecting section 102 also notifies the body weight calculating section 103 of the stay period.

In a case where the score calculating section 104A of the individual identifying section 104 is notified by the weight change detecting section 102 of any one of the entrance timing, the exit timing, and the stay period, the score calculating section 104A (i) calculates the score P1, P2, or P3 and (ii) retains a total value of a score for each individual. In a case where the score calculating section 104A has calculated all of the scores P1 through P3, the individual identifying section 104 (i) identifies an individual which has used the animal toilet 1 and (ii) records a body weight of the individual in the body weight data 132 of the storage section 13, as with the process described in Embodiment 1.

### Embodiment 3

A control block (particularly the weight obtaining section 100, the action information obtaining section 101, the weight change detecting section 102, the body weight calculating section 103, and the individual identifying section 104) of the control section 10 can be realized by a logic circuit (hardware) provided in an integrated circuit (IC chip) or the like or can be alternatively realized by software as executed by a central processing unit (CPU).

In the latter case, the control section 10 includes a CPU that executes instructions of a program that is software realizing the foregoing functions; a read only memory (ROM) or a storage device (each referred to as “storage medium”) in which the program and various kinds of data are stored so as to be readable by a computer (or a CPU); and a random access memory (RAM) in which the program is loaded. An object of the present invention can be achieved by a computer (or a CPU) reading and executing the program stored in the storage medium. Examples of the storage medium encompass “a non-transitory tangible medium” such as a tape, a disk, a card, a semiconductor memory, and a programmable logic circuit. The program can be made available to the computer via any transmission medium (such as a communication network or a broadcast wave) which allows the program to be transmitted. Note that an aspect of the present invention can also be achieved in the form of a computer data signal in which the program is embodied via electronic transmission and which is embedded in a carrier wave.

[Recap]

An individual identifying device (control section 10) in accordance with Aspect 1 of the present invention includes: a weight obtaining section (100) configured to obtain, at certain time intervals, a weight applied to a certain region; an action information obtaining section (101) configured to obtain one or more pieces of action information on respective ones of one or more animals, each of the one or more pieces of action information indicating whether or not a corresponding one of the one or more animals is moving; a weight change detecting section (102) configured to detect at least one of a timing and a period in each of which a change over time in the weight obtained by the weight obtaining section indicates a certain change; and an individual identifying section (104) configured to identify, based on the one or more pieces of action information in at least one of the timing and the period, an individual which stayed in the certain region.

It can be said that in a case where the change in weight applied to the certain region is due to the body weight of the animal, the weight applied to the certain region shows a certain pattern in change according to the action of the animal which enters and exits the certain region. With the configuration, therefore, it is possible to accurately identify an individual, which stayed in the certain region, through referring to the action information of each individual of animals when the weight indicates a certain change.

An individual identifying device in accordance with Aspect 2 of the present invention can be configured in Aspect 1 so that: the weight change detecting section is configured to detect, as a first timing (entrance timing), a timing at which the weight obtained by the weight obtaining section has become not less than a first threshold; and the individual identifying section is configured to identify, based on the one or more pieces of action information at the first timing, the individual which stayed in the certain region.

In a case where an animal enters the certain region, the weight applied to the certain region increases. With the configuration, therefore, it is possible to accurately identify, based on the action information obtained when the animal entered the certain region, an individual which stayed in the certain region.

An individual identifying device in accordance with Aspect 3 of the present invention can be configured in Aspect 1 or 2 so that: the weight change detecting section is configured to detect, as a weight stable period (stay period), a period in which an amount of change in the weight obtained by the weight obtaining section falls within a certain range; and the individual identifying section is configured to identify, based on the one or more pieces of action information in the weight stable period, the individual which stayed in the certain region.

In a case where an animal is staying in the certain region, the weight applied to the certain region is stable in a certain range. With the configuration, therefore, it is possible to accurately identify, based on the action information obtained while the animal is staying in the certain region, an individual which stayed in the certain region.

An individual identifying device in accordance with Aspect 4 of the present invention can be configured in any one of Aspects 1 through 3 so that: the weight change detecting section is configured to detect, as a second timing (exit timing), a timing at which the weight obtained by the weight obtaining section has become less than a second threshold; and the individual identifying section is configured to identify, based on the one or more pieces of action information at the second timing, the individual which stayed in the certain region.

In a case where an animal exits the certain region, the weight applied to the certain region decreases. With the configuration, therefore, it is possible to accurately identify, based on the action information obtained when the animal exited the certain region, an individual which stayed in the certain region.

An individual identifying device in accordance with Aspect 5 of the present invention can be configured in any one of Aspects 1 through 4 so that: the weight change detecting section is configured to (a) detect, as a first timing (entrance timing), a timing at which the weight obtained by the weight obtaining section has become not less than a first threshold, (b) detect, as a weight stable period (stay period), a period in which an amount of change in the weight falls within a certain range, and (c) detect, as a second timing (exit timing), a timing at which the weight has become less than a second threshold; and the individual identifying section is configured to (a) perform a first determination (S122) to determine whether or not the one or more pieces of action information at the first timing indicate(s) that a corresponding one(s) of the one or more animals is/are moving, (b) perform a second determination (S162) to determine whether or not the one or more pieces of action information in the weight stable period indicate(s) that the corresponding one(s) of the one or more animals is/are not moving, and (c) perform a third determination (S122) to determine whether or not the one or more pieces of action information at the second timing indicate(s) that the corresponding one(s) of the one or more animals is/are moving and identify, by comprehensively examining respective results of the first determination, the second determination, and the third determination, an animal which is present in the certain region.

With the configuration, therefore, it is possible to identify an individual, who stayed in the certain region, through comprehensively examining the pieces of action information obtained when (i) the animals entered the certain region, (ii) the animal stays in the certain region, and (iii) the animal exits the certain region. This leads to an increase in accuracy of identification of an individual.

An individual identifying system in accordance with Aspect 6 of the present invention includes: an individual identifying device (control section 10) according to any one of Aspects 1 through 5; one or more action information detecting devices (acceleration sensor 20) configured to detect a corresponding one(s) of the one or more pieces of action information on respective ones of one or more animals; and a weight measuring device (weight scale 12) configured to measure a weight applied to the certain region, the action information obtaining section being configured to obtain the one or more pieces of action information from the one or more action information detecting devices, the weight obtaining section being configured to obtain the weight from the weight measuring device, and the individual identifying device being configured to identify, based on the weight measured by the weight measuring device, an animal which is present in the certain region.

With the configuration, an effect similar to that of the individual identifying device described in Aspect 1 can be obtained.

An individual identifying device controlling method in accordance with Aspect 7 of the present invention includes the steps of: (a) obtaining, at certain time intervals, a weight applied to a certain region; (b) obtaining one or more pieces of action information on respective ones of one or more animals, each of the one or more pieces of action information indicating whether or not a corresponding one of the one or more animals is moving; (c) detecting at least one of a timing and a period in each of which a change over time in the weight obtained in the step (a) indicates a certain change (at least one of S10, S14, and S20); and (d) identifying, based on the one or more pieces of action information in at least one of the timing and the period, an individual which stayed in the certain region (S24). With the configuration, an effect similar to that of the individual identifying device described in Aspect 1 can be obtained.

The individual identifying device according to the foregoing aspects of the present invention can be realized by a computer. In such a case, the following can be encompassed in the scope of the present invention: a control program for the individual identifying device which program causes a computer to operate as each section (software element) of the individual identifying device so that the individual identifying device can be realized by the computer; and a computer-readable storage medium in which the control program is stored.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1 Animal toilet
10 Control section (individual identifying device)
100 Weight obtaining section
101 Action information obtaining section
102 Weight change detecting section
103 Body weight calculating section
104 Individual identifying section
104A Score calculating section
11 Communication section
12 Weight scale (weight measuring device)
13 Storage section
130 Action information
131 Weight data
132 Body weight data
2 Collar
20 Acceleration sensor (action information detecting device)
3 Information processing terminal
4 Server
500 Management system (individual identifying system)

1. An individual identifying device comprising:
a weight obtaining section configured to obtain, at certain time intervals, a weight applied to a certain region;
an action information obtaining section configured to obtain one or more pieces of action information on respective ones of one or more animals, each of the one or more pieces of action information indicating whether or not a corresponding one of the one or more animals is moving;
a weight change detecting section configured to detect at least one of a timing and a period in each of which a change over time in the weight obtained by the weight obtaining section indicates a certain change; and
an individual identifying section configured to identify, based on the one or more pieces of action information in at least one of the timing and the period, an individual which stayed in the certain region.

2. The individual identifying device according to claim 1, wherein:
the weight change detecting section is configured to detect, as a first timing, a timing at which the weight obtained by the weight obtaining section has become not less than a first threshold; and
the individual identifying section is configured to identify, based on the one or more pieces of action information at the first timing, the individual which stayed in the certain region.

3. The individual identifying device according to claim 1, wherein
the weight change detecting section is configured to detect, as a weight stable period, a period in which an amount of change in the weight obtained by the weight obtaining section falls within a certain range; and
the individual identifying section is configured to identify, based on the one or more pieces of action information in the weight stable period, the individual which stayed in the certain region.

4. The individual identifying device according to claim 1, wherein
the weight change detecting section is configured to detect, as a second timing, a timing at which the weight obtained by the weight obtaining section has become less than a second threshold; and
the individual identifying section is configured to identify, based on the one or more pieces of action information at the second timing, the individual which stayed in the certain region.

5. The individual identifying device according to claim 1, wherein:
the weight change detecting section is configured to
(a) detect, as a first timing, a timing at which the weight obtained by the weight obtaining section has become not less than a first threshold, (b) detect, as a weight stable period, a period in which an amount of change in the weight falls within a certain range, and (c) detect, as a second timing, a timing at which the weight has become less than a second threshold; and
the individual identifying section is configured to
(a) perform a first determination to determine whether or not the one or more pieces of action information at the first timing indicate(s) that a corresponding one(s) of the one or more animals is/are moving, (b) perform a second determination to determine whether or not the one or more pieces of action information in the weight stable period indicate(s) that the corresponding one(s) of the one or more animals is/are not moving, and (c) perform a third determination to determine whether or not the one or more pieces of action information at the second timing indicate(s) that the corresponding one(s) of the one or more animals is/are moving and
identify, by comprehensively examining respective results of the first determination, the second determination, and the third determination, an animal which is present in the certain region.

6. An individual identifying system comprising:
an individual identifying device according to claim 1;
one or more action information detecting devices configured to detect a corresponding one(s) of the one or more pieces of action information on respective ones of one or more animals; and
a weight measuring device configured to measure a weight applied to the certain region,
the action information obtaining section being configured to obtain the one or more pieces of action information from the one or more action information detecting devices,
the weight obtaining section being configured to obtain the weight from the weight measuring device, and
the individual identifying device being configured to identify, based on the weight measured by the weight measuring device, an animal which is present in the certain region.

7. A method of controlling an individual identifying device, comprising the steps of:
(a) obtaining, at certain time intervals, a weight applied to a certain region;
(b) obtaining one or more pieces of action information on respective ones of one or more animals, each of the one or more pieces of action information indicating whether or not a corresponding one of the one or more animals is moving;
(c) detecting at least one of a timing and a period in each of which a change over time in the weight obtained in the step (a) indicates a certain change; and
(d) identifying, based on the one or more pieces of action information in at least one of the timing and the period, an individual which stayed in the certain region.

8. A non-transitory computer-readable storage medium storing therein a control program for causing a computer to serve as an individual identifying device according to claim 1, the program causing the computer to serve as each of the weight obtaining section, the action information obtaining section, the weight change detecting section, and the individual identifying section.
